(19) United States
(12) Patent Application Publication
(10) Pub. No.: US 2026/0110860 A1
(43) Pub. Date: Apr. 23, 2026

(54) DYNAMIC GUIDED AUTO ALIGNMENT SYSTEM AND METHOD FOR OPERATING THE SAME

(71) Applicant: Jabil Inc., St. Petersburg, FL (US)

(72) Inventor: Prebesh Pavithran, Bayan Lepas (MY)

(73) Assignee: Jabil Inc., St. Petersburg, FL (US)

(21) Appl. No.: 18/921,178

(22) Filed: Oct. 21, 2024

(51) Int. Cl. G02B 6/42

(52) U.S. Cl. CPC G02B 6/4221; G02B 6/4204; G02B 6/4239; G02B 6/424; G02B 6/4244; G02B 6/4249; G02B 6/428

(57) ABSTRACT

An auto alignment system is used with a base board that is mounted with at least one laser source, and a fiber array unit (FAU) that includes at least one lens facing the base board. The system includes a location determination unit configured to capture an image of the base board and the FAU, a processor, a motor, and a goniometer. The processor compares a current location of the FAU and an ideal position of the FAU, at which the at least one lens is aligned with the at least one laser source, and determines an offset value associated with the current location of the FAU and the ideal position of the FAU. Then, the processor controls the motor to actuate the goniometer to move the FAU to the ideal position based on the offset value.

### FIELD

The disclosure relates to an alignment system, and more particularly to a dynamic guided auto alignment system for optical transceivers and a method for operating the system.

### BACKGROUND

The applications of active alignment are widely used in different fields, such as camera modules, optical transceivers, or other processes that involve aligning different parts to assemble an apparatus. As the sizes of the parts become smaller, the demand for high precision alignment also increases.

In the case of optical transceivers, components included in a specific optical transceiver (e.g., optic sources, lenses, optical fiber cables, etc.) are typically built separately and then assembled. In order to ensure optimal power transmission, the optic sources, the lenses and the optical fiber cables are preferably aligned accurately.

FIG. 1 illustrates exemplary components included in a specific optical transceiver 100. The components include a fiber array unit (FAU) 110 that includes a plurality of lenses 112 corresponding with backend optical fibers (not shown in the drawing), and a printed circuit board (PCB) 120 that includes a die 122 (a block of semiconducting material for forming integrated circuits (ICs)) formed thereon. The die 122 may include Silicon photonics (SiPh) ICs formed thereon, and includes a plurality of laser sources 124. In use, the laser sources 124 on the die 122 are to be aligned to the lenses 112 of the FAU 110, respectively. After the alignment is completed, an adhesive material (e.g., epoxy) may be applied to secure the FAU 110 and the die 122 together, forming a part of the specific optical transceiver 100.

Generally, the FAU 110 is held by another component (e.g., a goniometer 130), and the goniometer 130 may be actuated to move the FAU 110 in different directions. However, during a manufacturing process for assembling the die 122 onto the PCB 120, the die 122 may not be located accurately on a desired location on the PCB 120. That is, a “die shift,” indicating a displacement (including a positional displacement and an angular displacement) between the expected location of the die 122 on the PCB 120 and an actual location of the die 122 on the PCB 120 may occur during the manufacturing process.

### SUMMARY

It is then desirable to provide a system that is capable of automatically aligning lenses with laser sources in response to a variety of die shifts.

Therefore, one object of the disclosure is to provide an auto alignment system that can alleviate at least one of the drawbacks of the prior art.

According to one embodiment of the disclosure, the auto alignment system is used with a base board that is mounted with at least one laser source, and a fiber array unit (FAU) that includes at least one lens facing the base board. The system includes a location determination unit, a processor, a motor, and a goniometer.

The location determination unit is configured to capture an image of the base board and the FAU. The processor is connected to the location determination unit to receive the image, and is programmed to perform an image processing procedure to compare a current location of the FAU, which is obtained based on the image, and an ideal position of the FAU, at which the at least one lens is aligned with the at least one laser source, and to determine an offset value associated with the current location of the FAU and the ideal position of the FAU.

The motor that is connected to the processor. The goniometer is connected to the motor. The processor is configured to control the motor to actuate the goniometer to move the FAU to the ideal position based on the offset value.

Another object of the disclosure is to provide a method for operating the above-mentioned system.

According to one embodiment of the disclosure, the method is for auto alignment between a base board that is mounted with at least one laser source, and a fiber array unit (FAU) that includes at least one lens facing the base board. The method is implemented using a system that includes a location determination unit, an image processor, a motor connected to the image processor, and a goniometer connected to the motor. The method includes:
a) capturing, by the location determination unit, an image of the base board and the FAU;
b) performing, by the image processor, an image processing procedure to compare a current location of the FAU, which is obtained based on the image, and an ideal position of the FAU, at which the at least one lens is aligned with the at least one laser source, and determining an offset value associated with the current location of the FAU and the ideal position of the FAU; and
c) controlling, by the image processor, the motor to actuate the goniometer to move the FAU to the ideal position based on the offset value.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 illustrates exemplary components included in a specific optical transceiver.

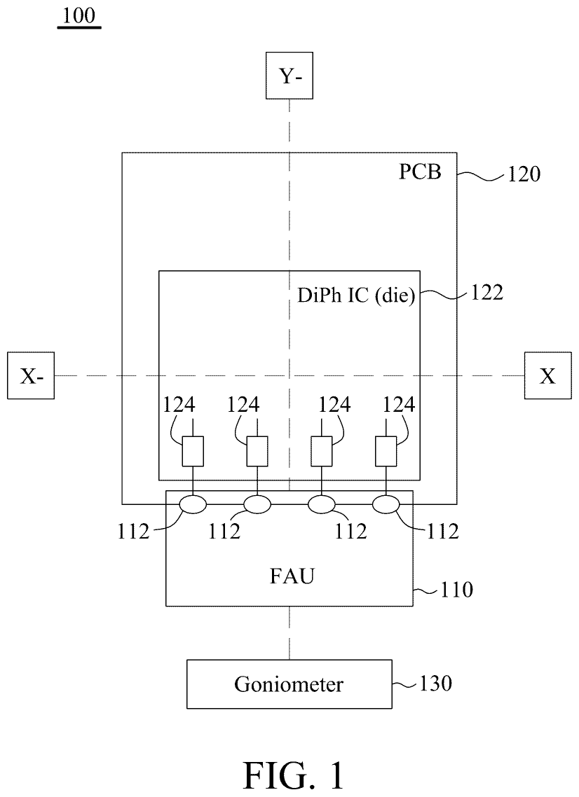

FIG. 2 is a schematic view illustrating a dynamic guided auto alignment system for optical transceivers according to one embodiment of the disclosure.

FIG. 3 is a flow chart illustrating steps of a method for automatically aligning lenses disposed on an FAU to laser sources on a die according to one embodiment of the disclosure.

FIG. 4 illustrates operations of the system in step 312 of the method according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

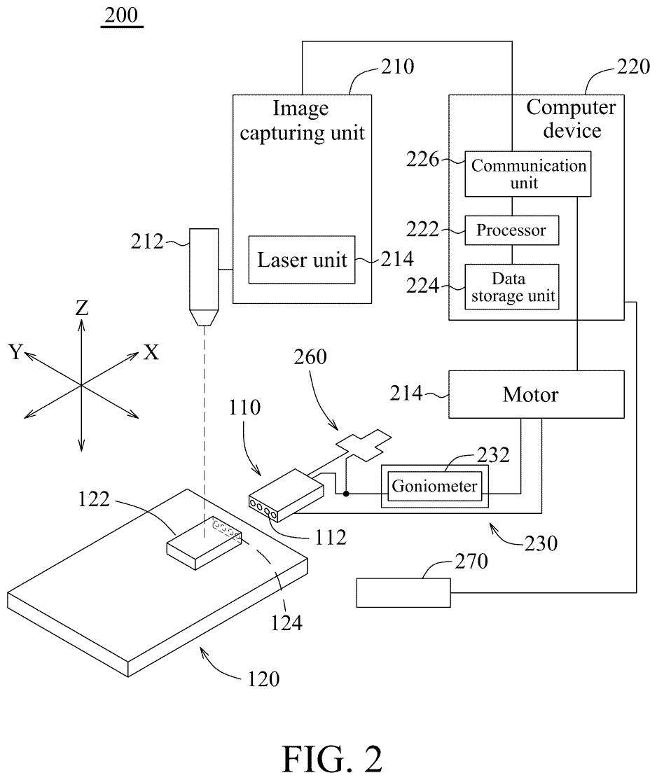

FIG. 2 is a schematic view illustrating a dynamic guided auto alignment system 200 for optical transceivers according to one embodiment of the disclosure. The system 200 is for aligning a number of lenses 112 disposed on a fiber array unit (FAU) 110 to a number of laser sources 124. In some embodiments, the lenses 112 correspond respectively with backend optical fibers included in a connector 260. The laser sources 124 in the embodiment of FIG. 2 are disposed on a base board, such as a printed circuit board (PCB) 120. A die 122 is a block of semiconductor material for forming integrated circuits (ICs) mounted on the PCB 120. In embodiments, the die 122 may include Silicon photonics (SiPh) ICs formed thereon to implement the laser sources 124. In the embodiment of FIG. 2, four lenses 112 and four laser sources 124 are present, but it is noted that in other embodiments, different numbers of lenses 112 and laser sources 124 may be provided. Generally, at least one lens 112 and at least one laser source 124 are provided.

In use, during an assembly process in which the die 122 is to be mounted on the PCB 120, the die 122 may be mounted on different locations on the PCB 120, resulting in a die shift, which indicates a displacement (including a positional displacement and an angular displacement) between an expected location of the die 122 on the PCB 120 and an actual location of the die 122 on the PCB 120. In order to accurately align the lenses 112 with the laser sources 124, respectively, a location of the FAU 110 may be moved according to a location of the die 122. In some cases, other parameters such as a height of the die 122, a rotation of the die 122 with respect to the PCB 120, a bond line thickness (BLT) associated with the die 122, etc., may also affect the location of the die 122.

As such, the system 200 includes a location determination unit 210, a computer device 220, a gripper 230, and a motor 240.

The location determination unit 210 is disposed to capture an image of the base board (e.g., the PCB 120) and the FAU 110. In some embodiments, the location determination unit 210 includes a camera 212 disposed above the PCB 120 and the FAU 110. In some embodiments, the location determination unit 210 further includes a laser unit 214 for performing operations, such as distance measurement for obtaining information regarding the PCB 120.

The computer device 220 may be embodied using an industrial computer, a server device or other suitable computer devices. The computer device 220 includes a processor 222, a data storage unit 224, and a communication unit 226. The processor 222 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. In some embodiments, the computer device 220 may include a specifically purposed image processor for performing the operations as described below.

The data storage unit 224 is connected to the processor 222, and may be embodied using, for example, one or more of random access memory (RAM), read only memory (ROM), programmable ROM (PROM), firmware, flash memory, etc. The data storage unit 224 stores a software application including instructions that, when executed by the processor 222, cause the processor 222 to perform operations and a calculating algorithm as described below.

The communication unit 226 is connected to the processor 222, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or the fifth generation (5G) of wireless mobile telecommunications technology, or the like. The communication unit 226 enables the computer device 220 to communicate with other components of the system 200.

The gripper 230 includes components that are configured to secure the FAU 110, and may include a goniometer 232. The goniometer 232 may be controlled to move the FAU 110 to rotate and/or move to specific locations. In embodiments, the goniometer 232 may be embodied using commercially available goniometers, and therefore the details of the operation of the goniometer 232 are omitted herein for the sake of brevity.

The motor 240 is connected to the computer device 220 and the gripper 230, and is controlled by the processor 222 to actuate the goniometer 232, therefore controlling the location of the FAU 110. In some embodiments, the motor 240 and the goniometer 232 may be integrated as a motorized goniometer stage.

It is noted that the data storage unit 224 may store a database that includes information such as an image indicating an ideal position of the FAU 110 relative to the die 122, a lookup table including information between different locations of the die 122 and corresponding ideal positions of the FAU 110, a calculation algorithm for performing specific calculations as described below, etc.

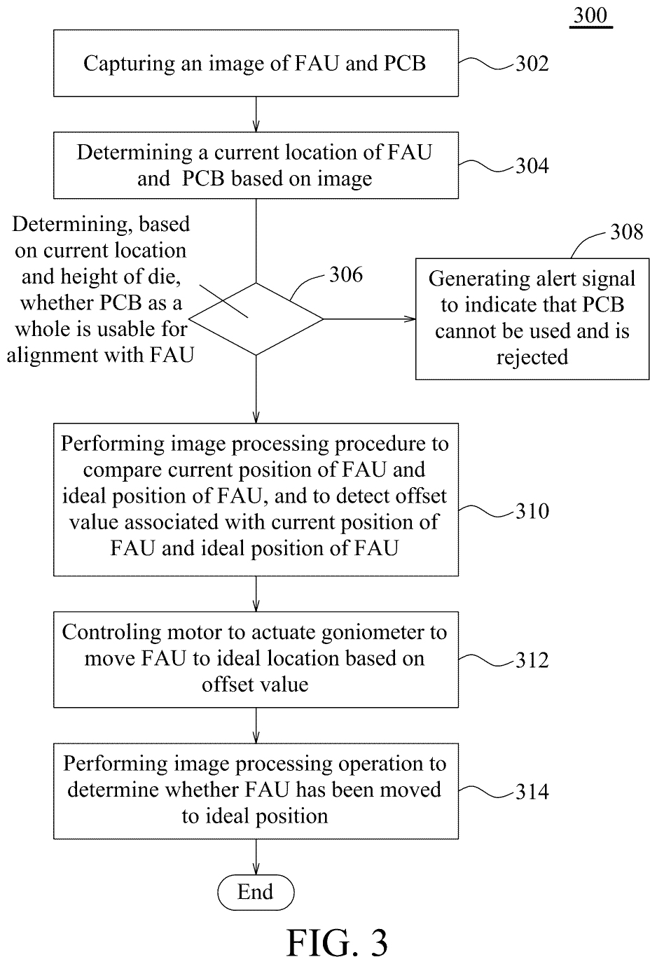

FIG. 3 is a flow chart illustrating steps of a method 300 for automatically aligning the lenses 112 of the FAU 110 to the laser sources 124 of the die 122 according to one embodiment of the disclosure. In the embodiment of FIG. 3, the method is implemented using the system 200 of FIG. 2.

In use, after the FAU 110 is secured by the gripper 230 and the PCB 120 with the die 122 is provided, the method may be initiated in an attempt to align the lenses 112 to the laser sources 124.

In step 302, the location determination unit 210 is activated by the processor 222 to capture an image of the FAU 110 and the PCB 120. In embodiments, step 302 may include the camera 212 capturing the image and the laser unit 214 performing a distance measurement to determine a distance between the laser unit 214 and the die 122 (therefore, a height of the die 122 with respect to a reference plane, e.g., the ground, is obtained).

In step 304, in response to receipt of the image, the processor 222 determines a current location of the FAU 110 and a current location of the die 122 on the PCB 120 based on the image. Specifically, the processor 222 may execute an image identification algorithm to determine the current location of the die 122 on the PCB 120, and an angular position of the die 122 related to a horizontal plane.

In step 306, the processor 222 determines, based on the current location, the angular position and the height of the die 122, whether the PCB 120 as a whole is usable for alignment with the FAU 110. In other words, the processor 222 determines whether the alignment between the laser sources 124 and the lens 112 can be implemented. Specifically, in embodiments, the die 122 may have die shifts that exceed a set of predetermined allowances. In a case where the die 122 has an angular position that exceeds one allowance in the set of predetermined allowances on a Z-axis (see FIG. 2); that is, when a side of the die 122 with the laser sources 124 tilts upwardly or downwardly, it may be determined that the lenses 112 of the FAU 110 cannot be accurately aligned with the laser sources 124 on the die 122 using the goniometer 232, and the flow proceeds to step 308, in which the processor 222 generates an alert signal to indicate that the PCB 120 cannot be used and is rejected from following procedures, and another PCB 120 needs to be provided. As such, the method is terminated, stopping the operation of alignment. In some embodiments where the laser unit 214 is provided, in a case where the distance detected by the laser unit 214 indicates that the height of the die 122 is too high or too low (e.g., outside a pre-stored range in the data storage unit 224), the flow may also proceed to step 308 to generate the alert signal. In other cases, when the current location of the die 122 on a horizontal plane (defined by an X-axis and a Y-axis as shown in FIG. 2) indicates a die shift that is greater than a pre-stored threshold, the flow may also proceed to step 308 to generate the alert signal.

Otherwise, in the case that the determination of step 306 is affirmative, the flow proceeds to step 310, in which the processor 222 performs an image processing procedure to compare the current location of the FAU 110 and an ideal position of the FAU 110, at which the at least one lens 112 is aligned with the at least one laser source 124, and to detect an offset value associated with the current location of the FAU 110 and the ideal position of the FAU 110. In some embodiments, the image processing procedure may include overlaying a pre-stored image, in which the die 122 is located at an ideal position and the FAU 110 and the die 122 are already aligned, onto the image captured by the location determination unit 210, so as to first determine whether the die 122 is at the ideal position indicated by the pre-store image. In the case that the die 122 is at the ideal position, the processor 222 may use a position of the FAU 110 indicated in the pre-stored image as the ideal position, and calculate the offset value based on the ideal position of the FAU 110 and the current location of the FAU 110. On the other hand, in the case that the die 122 is not at the ideal position (i.e., a die shift is present), the processor 222 may perform a calculating algorithm to calculate the ideal position of the FAU 110 based on the current location of the die 122, and calculate the offset value based on a newly calculated ideal position of the FAU 110 and the current location of the FAU 110. In some embodiments, the offset value may be represented by a vector on the horizontal plane defined by the X-axis and the Y-axis.

It is noted that the ideal position of the FAU 110 is calculated based on the current location of the die 122, so as to determine how the FAU 110 should be moved to align the lenses 112 to the laser sources 124.

Then, in step 312, the processor 222 controls the motor 240 to actuate the goniometer 232 to move the FAU 110 to the ideal position based on the offset value calculated in step 310. As such, the lenses 112 may be accurately aligned with the laser sources 124, respectively.

In some embodiments, after the alignment is completed, an adhesive material (such as epoxy) may be applied to secure the FAU 110 and the die 122 together, forming a part of an optical transceiver. With the lenses 112 accurately aligned with the laser sources 124, efficiency of power transmission of the resulting optical transceiver may be optimized. Generally, the application of the adhesive material may be done using a packaging unit 270 that is connected to the computer device 220, and that stores the adhesive material therein (e.g., an adhesive dispenser). In use, the packaging unit 270 may be controlled by the processor 222 of the computer device 220 to apply the adhesive material.

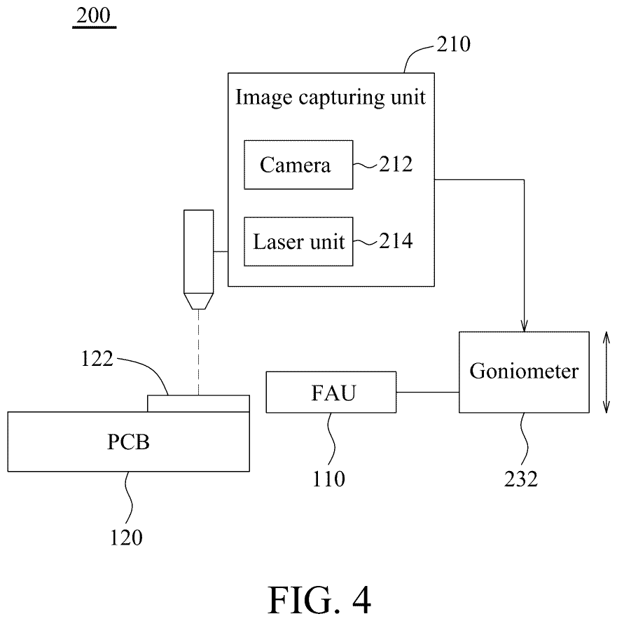

FIG. 4 illustrates the operations of the system 200 in step 312 according to one embodiment of the disclosure. In the embodiment of FIG. 4, the location determination unit 210 includes the camera 212 and the laser unit 214 for capturing the image of the FAU 110 and the PCB 120 and for determining the height of the die 122, respectively. Afterwards, the processor 222 calculates the ideal position of the FAU 110 based on the image, and obtains the offset value of the FAU 110. Then, the processor 222 controls the motor 240 to actuate the goniometer 232 to move the FAU 110 to the ideal position according to the offset value.

It is noted that, generally, in order to achieve the alignment, the FAU 110 and the die 122 need to be placed to be co-planar with each other as shown in FIG. 4. As such, in the case that the die 122 is formed to be tilted with respect to the horizontal plane or is too high/low for the goniometer 232, the PCB 120 may be rejected because accurate alignment cannot be achieved.

In some embodiments, after the application of the adhesive material, the laser unit 214 may be controlled to detect a distance between the laser unit 214 and the resulting optical transceiver. In some cases, a thickness of the optical transceiver (which may be derived using a difference of the distances detected prior to and after the application of the adhesive material, and a thickness of the PCB 120 which is known) may change due to the application of the adhesive material on the die 122, and therefore should also be monitored for determining whether the thickness is within another pre-stored range. In a case that the thickness of the optical transceiver is determined to be outside the another pre-stored range, the processor 222 may generate another alert signal.

In some embodiments, the method may further include verification operations. Specifically, during the operation in which the FAU 110 is being moved by the goniometer 232 toward the ideal position, in step 314, the camera 212 may continue to capture images of the PCB 120 and the FAU 110, so as to enable the processor 222 to perform the image processing procedure to determine whether the FAU 110 has been moved to the ideal position (e.g., along direction of a Y-axis as indicated in FIG. 2), and whether the position of the PCB 120 has changed. In some embodiments, the laser unit 214 may also be activated to continuously detect the distance between the laser unit 214 and the die 122 along the Z-axis, and the processor 222 may determine whether the distance has changed during the movement of the FAU 110 by the goniometer 232. As such, the verification operation monitors whether there are any unexpected movements of the PCB 120 and/or the FAU 110 during the method, and when such unexpected movements are detected (that is, the position of the die 122 has changed or the distance has changed), the processor 222 may execute the calculating algorithm or use the lookup table to calculate an updated ideal position of the FAU 110.

In some embodiments, after the method is completed, the associated data (e.g., the current locations of the FAU 110 and the die 122, the height of the die 122, the resulting ideal position of the FAU 110 calculated using the calculation algorithm, etc.) may be stored in the data storage unit 224 as a part of the lookup table.

As such, in subsequent iteration of the method, in the case that the current locations of the FAU 110 and the die 122 and the height of the die 122 come up again (i.e., can be found in the lookup table), the processor 222 may directly use the ideal position of the FAU 110 to calculate the offset value that can be used to control the motor 240, further reducing the time needed for calculation. Generally, the processor 222 is programmed to determine the offset value by first determining whether the current location of the die 122 can be found in the lookup table, and in the case that the current location of the die 122 can be found in the lookup table, the processor 222 uses the lookup table to determine the corresponding ideal position of the FAU 110, and uses the ideal position of the FAU 110 to calculate the offset value. Otherwise, in the case that the current location of the die 122 cannot be found in the lookup table, the processor 222 uses the calculating algorithm to calculate the ideal position of the FAU 110 based on the current location of the die 122, and to calculate the offset value based on the ideal position of the FAU 110 and the current location of the FAU 110.

To sum up, the embodiments of the disclosure provide a system and a method for dynamically performing auto alignment of at least one lens on a fiber array unit (FAU) and a laser source on a die of a base board. In the method, a location determination unit is configured to obtain an image of the base board and the FAU. A processor of a computer device is configured to obtain an ideal position of the FAU based on the image. Specifically, the ideal position of the FAU is obtained based on a current location of the die obtained from the image. Then, the processor calculates an offset value, and controls a motor to actuate a goniometer connected to the FAU to move the FAU to the ideal position, at which the lens is aligned with the laser source. As such, a resulting optical transceiver may have optimal power transmission efficiency even with the presence of various die shifts. Therefore, the method may be implemented automatically with improved accuracy. Additionally, using a laser unit to detect a height of the die, the system may further reject base boards that cannot have the FAU properly aligned with dies on the base boards.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An auto alignment system, the system being used with a base board that is mounted with at least one laser source, and a fiber array unit (FAU) that includes at least one lens facing the base board, the system comprising:
a location determination unit that is configured to capture an image of the base board and the FAU;
a processor that is connected to the location determination unit to receive the image, and that is programmed to perform an image processing procedure to compare a current location of the FAU, which is obtained based on the image, and an ideal position of the FAU, at which the at least one lens is aligned with the at least one laser source, and to determine an offset value associated with the current location of the FAU and the ideal position of the FAU;
a motor that is connected to the processor; and
a goniometer that is connected to the motor, wherein the processor is configured to control the motor to actuate the goniometer to move the FAU to the ideal position based on the offset value.

2. The system as claimed in claim 1, wherein the location determination unit includes a camera disposed above the base board and the FAU for capturing the image.

3. The system as claimed in claim 2, wherein:
the location determination unit further includes a laser unit for performing a distance measurement to determine a distance between the laser unit and the at least one laser source on the base board;
wherein the processor is further programmed to:
determine whether alignment between the at least one laser source and the at least one lens can be implemented based on the distance between the laser unit and the at least one laser source on the base board; and
in a case where the distance is outside a pre-stored range, generate an alert signal and stop operation for the alignment.

4. The system as claimed in claim 3, wherein:
while the FAU is being moved by the goniometer toward the ideal position,
the camera is configured to continuously capturing images of the base board and the FAU, so as to enable the processor to perform the image processing procedure to continuously determine whether the FAU has been moved to the ideal position and whether a position of the base board has changed, and
the laser unit is configured to continuously detect a distance between the laser unit and the base board, so as to enable the processor to continuously determine whether the distance has changed; and
in a case where the position of the base board has changed or the distance has changed, the processor calculates an updated ideal position of the FAU.

5. The system as claimed in claim 1, further comprising a computer device that includes the processor and a data storage unit, wherein the data storage unit stores a calculating algorithm that enables the processor to calculate the ideal position of the FAU based on a current location of the at least one laser source, and to calculate the offset value based on the ideal position of the FAU and the current location of the FAU.

6. The system as claimed in claim 5, wherein:
the data storage unit further stores a lookup table including information between different locations of the at least one laser source and corresponding ideal positions of the FAU;
the processor is programmed to determine the offset value by first determining whether the current location of the at least one laser source can be found in the lookup table, and in a case where the current location of the at least one laser source can be found in the lookup table, the processor uses the lookup table to determine the corresponding ideal position of the FAU, and uses the corresponding ideal position of the FAU to calculate the offset value; and
in a case where the current location of the at least one laser source cannot be found in the lookup table, the processor uses the calculating algorithm to calculate the ideal position of the FAU based on the current location of the at least one laser source, and to calculate the offset value based on the ideal position of the FAU and the current location of the FAU.

7. The system as claimed in claim 1, further comprising a computer device that includes the processor and a data storage unit, wherein:
the data storage unit stores a lookup table including information between different locations of the at least one laser source and corresponding ideal positions of the FAU; and
the processor is programmed to determine the offset value by using the lookup table to determine the ideal position of the FAU, and using the ideal position of the FAU to calculate the offset value.

8. The system as claimed in claim 1, further comprising a packaging unit that is connected to the processor and that is controlled by the processor to apply an adhesive material to secure the FAU and the at least one laser source on the base board together after the FAU is moved to the ideal position.

9. The system as claimed in claim 8, wherein:
the location determination unit includes a laser unit for performing a distance measurement to determine a distance between the laser unit and the at least one laser source on the base board; and
the laser unit is controlled to, after the application of the adhesive material, detect a distance between the laser unit and a resulting optical transceiver, which is formed by securing the FAU and the at least one laser source on the base board together.

10. The system as claimed in claim 9, wherein:
the processor determines a thickness of the optical transceiver based on the distance between the laser unit and the optical transceiver; and
in a case that the thickness of the optical transceiver is determined to be outside another pre-stored range, the processor generates an alert signal.

11. A method for auto alignment between a base board that is mounted with at least one laser source, and a fiber array unit (FAU) that includes at least one lens facing the base board, the method being implemented using a system that includes a location determination unit, an image processor, a motor connected to the image processor, and a goniometer connected to the motor, the method comprising:
a) capturing, by the location determination unit, an image of the base board and the FAU;
b) performing, by the image processor, an image processing procedure to compare a current location of the FAU, which is obtained based on the image, and an ideal position of the FAU, at which the at least one lens is aligned with the at least one laser source, and determining an offset value associated with the current location of the FAU and the ideal position of the FAU; and
c) controlling, by the image processor, the motor to actuate the goniometer to move the FAU to the ideal position based on the offset value.

12. The method as claimed in claim 11, the location determination unit including a camera disposed above the base board and the FAU, wherein step a) includes activating the camera for capturing the image.

13. The method as claimed in claim 12, the location determination unit further including a laser unit, wherein step a) further includes performing a distance measurement to determine a distance between the laser unit and the at least one laser source on the base board;
wherein step b) further includes:
determining whether alignment between the at least one laser source and the at least one lens can be implemented based on the distance between the laser unit and the at least one laser source on the base board; and
in a case where the distance is outside a pre-stored range, generating an alert signal and terminating the method.

14. The method as claimed in claim 13, further comprising:
during step c),
continuously capturing, by the camera, images of the base board and the FAU, so as to enable the image processor to perform the image processing procedure to continuously determine whether the FAU has been moved to the ideal position and whether a position of the base board has changed, and
continuously detecting, by the laser unit, a distance between the laser unit and the base board, so as to enable the image processor to continuously determine whether the distance has changed; and
in a case where the position of the base board has changed or the distance has changed, calculating, by the image processor, an updated ideal position of the FAU.

15. The method as claimed in claim 11, further being implemented using a computer device that includes the image processor and a data storage unit, the data storage unit storing a calculating algorithm, wherein:
step b) includes using the calculating algorithm to calculate the ideal position of the FAU based on a current location of the at least one laser source, and to calculate the offset value based on the ideal position of the FAU and the current location of the FAU.

16. The method as claimed in claim 15, the data storage unit further storing a lookup table including information between different locations of the at least one laser source and corresponding ideal positions of the FAU, wherein step b) includes:
determining the offset value by first determining whether the current location of the at least one laser source can be found in the lookup table, and in a case where the current location of the at least one laser source can be found in the lookup table, determining using the lookup table, the corresponding ideal position of the FAU, and calculating the offset value using the corresponding ideal position of the FAU; and
in a case where the current location of the at least one laser source cannot be found in the lookup table, calculating using the calculating algorithm, the ideal position of the FAU based on the current location of the at least one laser source, and calculating the offset value based on the ideal position of the FAU and the current location of the FAU.

17. The method as claimed in claim 11, further being implemented using a computer device that includes the image processor and a data storage unit, the data storage unit storing a lookup table that includes information between different locations of the at least one laser source and corresponding ideal positions of the FAU, wherein step b) includes determining the offset value by using the lookup table to determine the ideal position of the FAU, and using the ideal position of the FAU to calculate the offset value.

18. The method as claimed in claim 11, further being implemented using a packaging unit, the method further comprising, after step c): controlling, by the image processor, the packaging unit to apply an adhesive material to secure the FAU and the at least one laser source on the base board together.

19. The method as claimed in claim 18, the location determination unit including a laser unit for performing a distance measurement to determine a distance between the laser unit and the at least one laser source on the base board;
the method further comprising, after the application of the adhesive material, detecting a distance between the laser unit and a resulting optical transceiver, which is formed by securing the FAU and the at least one laser source on the base board together.

20. The method as claimed in claim 19, further comprising:
determining a thickness of the optical transceiver based on the distance between the laser unit and the optical transceiver; and
in a case that the thickness of the optical transceiver is determined to be outside another pre-stored range, generating an alert signal.
